(19) United States
(12) Patent Application Publication
(10) Pub. No.: US 2006/0091586 A1
(43) Pub. Date: May 4, 2006

(54) Surface preparation and thickness control for sprayed laminate parts

(75) Inventors: Mel Saccomanno, Counce, TN (US); Eddie Robinson, Bethel Springs, TN (US); Graylin Pusser, Savannah, TN (US); Brent Thomas, Adamsville, TN (US)

Correspondence Address: CARLSON, GASKEY & OLDS, P.C., 400 WEST MAPLE ROAD, SUITE 350, BIRMINGHAM, MI, 48009, US

(73) Assignee: Aqua Glass Corporation

(21) Appl. No.: 10/977,811

(22) Filed: Oct. 29, 2004

(51) Int. Cl. B29C 43/02

(52) U.S. Cl. 264/319; 425/128; 425/111

(57) ABSTRACT

A laminated article includes a first layer coated onto the mold to provide a smooth show surface. The first layer is covered with subsequent structural layers that comprise reinforcement material for providing the desired rigidity and strength required for the finished laminated article. An opening is surrounded by a surface and the surface is treated to provide a smooth and flat finish of a desired thickness for sealing with a subsequently installed plumbing fixture. The surface is prepared with an application device and a plastic sheet. The plastic sheet is placed over the surface and the device is pressed against the plastic sheet and into the third layer. The device presses against the plastic sheet and into the third layer to both smooth and flatten the surface to a desired finish.

### BACKGROUND OF THE INVENTION

This invention relates to a method and device for fabrication of a laminated article. More particularly, this invention relates to a method and device for preparation and control of a surface finish and thickness of a laminated article.

A laminated article, for example a bathtub, is fabricated by application of several layers over a mold. A first layer is applied to the mold that forms the outer surface that is exposed and visible. Subsequent layers of material are applied onto the first layer to provide structural rigidity of the laminated article. Once the layers dry the article is removed and ready for finish processing.

Laminated articles such as a bathtub include openings for plumbing fixtures such as water faucets and drain mechanisms. The first surface that is adjacent the mold includes a smooth finish that is defined by the contours of the mold. However, subsequent layers that are not adjacent the mold do not form smooth finished surfaces. Further, it is not necessary for most portions of the back non-visible side of the laminated article to include a smooth and defined finish.

However, openings within the article for plumbing fixtures require a smooth and level surface to provide surfaces for seals. Typically, such smooth flat surfaces are fabricated in a secondary process after the article is cured and hardened. A grinder or sander is used to prepare the desired flat and smooth surface adjacent the openings for the plumbing fixtures. Disadvantageously, such grinding and sanding process create significant amounts of dust that must be evacuated and isolated from the spray areas where laminate layers are applied. Further, grinding can only be done after the laminated article has fully cured. Additionally, grinding the surface of the laminated article is inconsistent causing scrap and necessary rework of the completed laminated articles.

Accordingly, it is desirable to design and develop a method and device for providing the desired surface finish and thickness without grinding or sanding areas of a laminated article.

### SUMMARY OF THE INVENTION

This invention is a method and device for creating a surface finish and thickness in a structural layer of a laminated article.

An example laminated article includes a first layer coated onto a mold to provide a smooth show surface. The first layer is preferably sprayed onto the mold and cured to form a smooth hard surface desirable on the viewable side of the bathtub. The first layer is covered with subsequent structural layers that comprise reinforcement material for providing the desired rigidity and strength required for the finished laminated article. An opening is surrounded by a surface that is treated to provide a smooth and flat finish desirable and necessary for providing a seal with subsequently installed plumbing fixtures. Further, a thickness between the surface and the show side of the first layer is defined and provided to accommodate installation of a plumbing fixture.

The surface is prepared with an application device and a plastic sheet. The plastic sheet is placed over the surface and the device is pressed against the plastic sheet and into the third layer. The device includes pointers that penetrate the third layer to seat on the cured or substantially cured second layer. The device presses the plastic sheet against the uncured third layer to define the surface. The device presses against the plastic sheet and into the third layer to both smooth and flatten the surface to a desired finish. The desired surface finish provides a flat and smooth sealing surface for application of seals corresponding to the subsequently installed drain hardware.

The device is removed after being pressed into the surface and set against the second layer. The surface is smoothed by the surface provided by the plastic sheet and flattened as desired by the plate. Removal of the device leaves the surface in the desired state. The plastic sheet is left in place to protect the surface from subsequent application of covering and materials that may be applied to the molded article.

The device and method according to this invention provide for the preparation and treatment of the surface without the need for waiting until the third layer is fully cured, as would be required by grinding operations. Further, the device provides significant control over the formation of the surface and the desired thickness to provide consistent thickness and surface preparation for the subsequently installed drain fixture.

These and other features of the present invention can be best understood from the following specification and drawings, the following of which is a brief description.

### BRIEF DESCRIPTION OF THE DRAWINGS

FIG. 1 is a perspective view of an example laminated article with a device for preparing a surface according to this invention.

FIG. 2 is a cross-sectional view an example device and laminated article according to this invention.

FIG. 3 is a plan view of the device according to this invention.

FIG. 4 is a cross-sectional view of the device according to this invention.

FIG. 5 is a cross-sectional view of the device pressed against a surface of the laminated article to prepare the desired area.

FIG. 6 is a cross-sectional view of the area of treatment on the example laminated article with the device removed.

FIG. 7 is a cross-sectional view of the completed laminated article.

### DETAILED DESCRIPTION OF THE PREFERRED EMBODIMENT

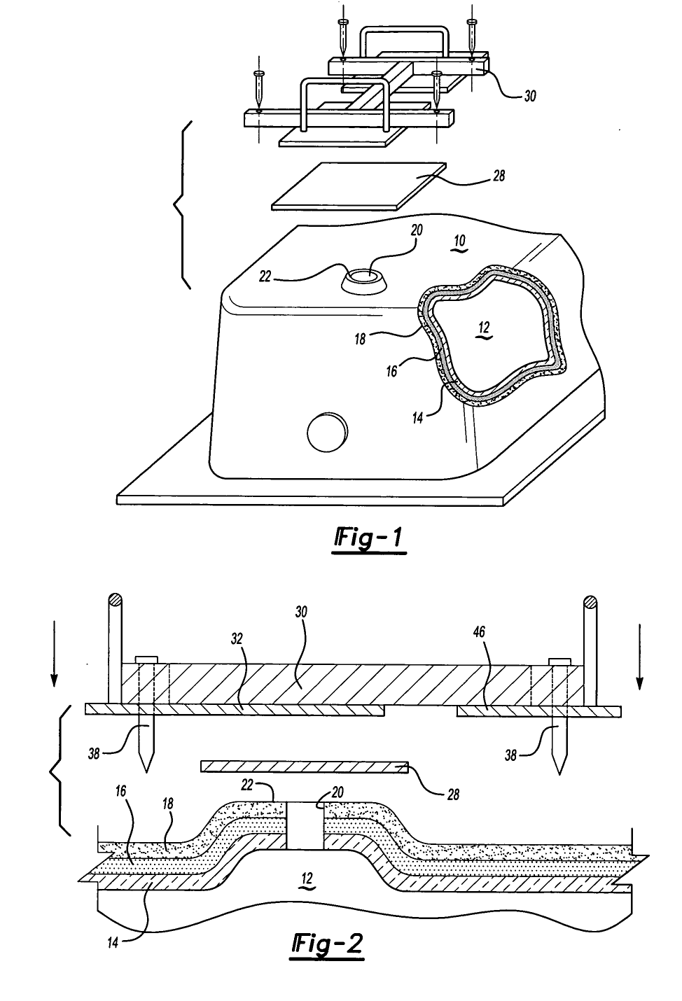

Referring to FIG. 1, a bathtub 10 is shown as an example of a laminated article fabricated utilizing a mold 12. A first layer 14 is coated onto the mold 12 to provide a smooth show surface. The first layer 14 is preferably sprayed onto the mold 12 and cured to form a smooth hard surface desirable on the viewable side of the bathtub 10. Preferably, the first layer 14 provides a hard porcelain like surface that is desirable and common for the bathtub 10 along with other fixtures such as sinks.

The first layer 14 is covered with subsequent structural layers that comprise reinforcement material that provide the desired rigidity and strength for the finished bathtub 10. The example bathtub 10 includes a second layer 16 and a third layer 18. As appreciated, the example bathtub 10 is illustrated with three layers, however, additional layers are within the contemplation of this invention. Three layers are illustrated and discussed to simplify the explanation of the method according to this invention. Additional layers may be utilized prior to, or after formation of the desired surface of the bathtub 10.

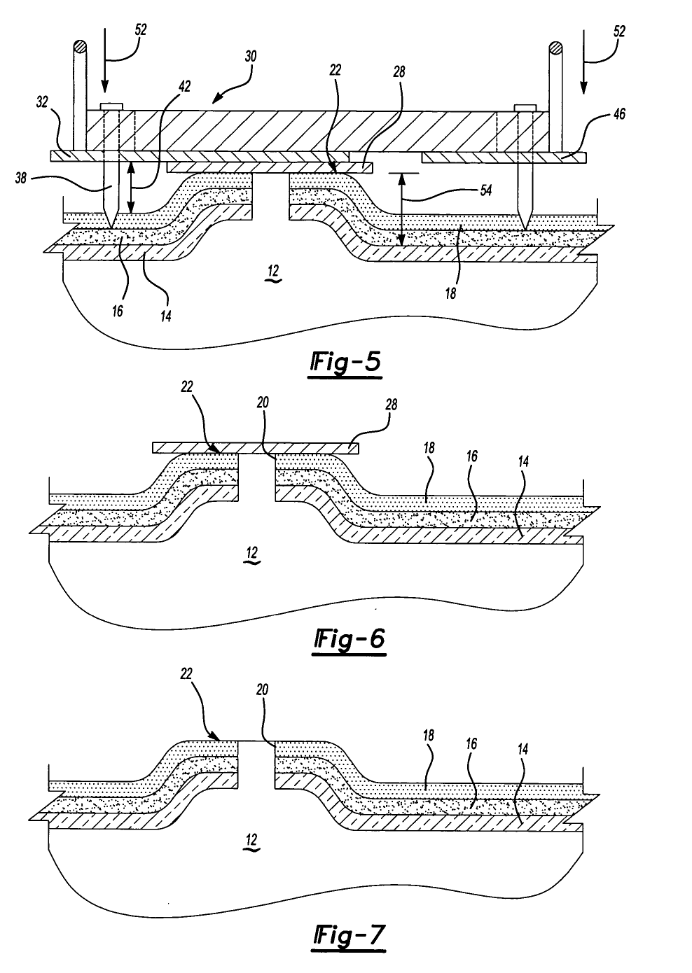

The bathtub 10 includes an opening 20 for a drain. The opening 20 is surrounded by a surface 22. The surface 22 is treated to provide a smooth and flat finish desirable and necessary for providing a seal with subsequently installed plumbing fixtures (not shown) for the drain. Further, a thickness 54 (FIG. 5) between the surface 22 and the show side of the first layer 14 is defined and provided to accommodate installation of the drain. The surface 22 is prepared with an application device 30 and a plastic sheet 28. The plastic sheet 28 is placed over the surface 22 and the device 30 is pressed against the plastic sheet 28 and into the third layer 18.

Referring to FIG. 2, the device 30 includes pointers 38 that penetrate the third layer 18 to seat on the cured or substantially cured second layer 16. The device 30 presses the plastic sheet 28 against the uncured third layer 18 to define the surface 22. The remainder of the third layer 18 includes the untreated surface finish. The device 30 presses against the plastic sheet 28 and into the third layer 18 to both smooth and flatten the surface 22 to a desired finish. The desired finish of the surface 22 provides the flat and smooth sealing surface for application of seals corresponding to the subsequently installed drain hardware.

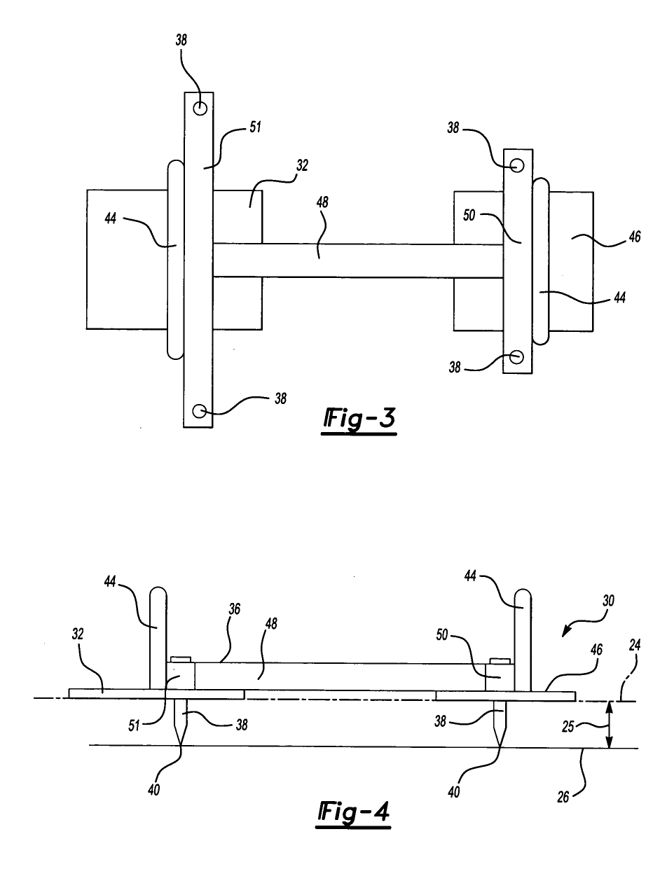

Referring to FIGS. 3 and 4, the device 30 includes a first plate 32 that includes a surface 34 that defines a first plane 24. The device 30 includes a body supporting the plate 32 along with the pointers 38. There are at least three pointers 38, each including a tip 40 that define a second plane 26. The first plane 24 and the second plane 26 are spaced apart a distance 25. The distance 25 is adjustable by selectively extending each of the pointers 38. The body 36 includes a cross bar 48 connecting a first lateral bar 50 to a second lateral bar 51. The example device 30 includes a second plate 46 that includes a second surface 45 that is also disposed within the first plane 24. The second plate 46 is smaller in area than the first plate 32 and can be utilized for a specific surface on the bathtub 10.

The pointers 38 include threads received within the lateral bars 50, 51. Threading inward and outward of the pointers 38 adjust the distance 25 between the spaced apart first and second planes 24, 26. Each of the pointers 38 includes pointed tips 40 for penetrating the uncured layer and abutting the cured or substantially cured second layer 16. As appreciated, the illustrated embodiment includes three layers; however many other layers can be provided and are within the contemplation of this invention. The tips 40 minimize penetration and disruption to the third layer 18 such that upon curing no significant inconsistency is visible to disrupt desired structural features of the completed bathtub 10. The device 30 further includes handles 44 for manipulating and applying a force to displace and form the surface 22.

Referring to FIG. 5, the surface 22 is prepared by first placing the plastic sheet 28 onto the surface 22. The surface 22 at this point of the process is in an as sprayed condition. The as sprayed condition can include thickness inconsistencies as well as pits and other undesirable surface irregularities not desirable for a sealing surface. The plastic sheet 28 provides a barrier between the uncured material comprising the third layer 18 and the surface 34 of the device 30. The plastic sheet 28 prevents the uncured material from possibly sticking to the surface 34 of the plate 32 and disrupting the desired completed surface finish.

A force indicated by arrows 52 is applied to the handles 44 downwardly to push the device 30 onto the bathtub 10. The pointers 38 and specifically the tips 40 penetrate the third layer 18 and abut against the substantially cured and rigid underlying second layer 16. The underlying second surface 16 provides a rigid and positive location on which the device 30 can sit.

The distance 25 between the first plane 24 and the second plane 26 corresponds with a desired thickness 54 between the show side surface of the first layer 14 and the surface 22. The thickness 54 provides for the assembly of a drain assembly and is desired to be maintained within predetermined and desired tolerances. The pointers 38 may be adjusted as desired to tailor the thickness 54 to process parameters and application specific requirements.

Referring to FIG. 6, the device 30 is removed after being pressed into the surface 22 and set against the second layer 16. The surface 22 is smoothed by the surface provided by the plastic sheet 28 and flattened as desired by the plate 32. Removal of the device 30 leaves the surface 22 in the desired state. The plastic sheet 28 is left in place to protect the surface 22 from subsequent application of covering and materials that may be applied to the bathtub 10. Further, the plastic sheet 28 is left in place until the third layer 18 is cured to a point where removal of the plastic sheet 28 will not cause damage to the surface 22.

Referring to FIG. 7, once the third layer has cured sufficiently, the plastic sheet 28 is removed to expose the surface 22. The surface 22 provides a sufficiently flat and smooth as is desired to provide the required sealing surface for a drain assembly.

The device 30 and method according to this invention provides for the preparation and treatment of the surface 22 without the need for waiting until the third layer is fully cured, as would be required by grinding operations. Further, the device 30 provides significant control over the formation of the surface and the desired thickness to provide consistent thickness and surface preparation for the subsequently installed plumbing fixtures.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method for preparing a surface of a laminated article comprising the steps of:
a. applying a sheet of material to a surface of a laminated article while the surface is in an uncured condition:
b. pressing a device onto said sheet and against the surface of the laminated article to a desired depth;
c. removing the device; and
d. removing the sheet once the surface of the laminated article has cured.

2. The method as recited in claim 1, including the step of applying a first layer directly onto a mold and subsequent layers over the first layer.

3. The method as recited in claim 2, wherein said step a. is performed after at least one of the subsequent layers is applied over the first layer.

4. The method as recited in claim 1, wherein said sheet of material comprises a plastic sheet.

5. The method as recited in claim 1, wherein said surface of the laminated article is disposed adjacent an opening through the laminated article.

6. The method as recited in claim 5, wherein said opening is for a drain opening within the laminated article.

7. The method as recited in claim 1, wherein said step b. includes providing at least three pointers extending from a flat surface of the device and defining the desired thickness between a point of the at least three pointers and the flat surface.

8. The method as recited in claim 7, wherein said step b. includes engaging a substantially cured layer of the laminated article for defining a thickness of the uncured layer.

9. The method as recited in claim 1, including applying additionally layers of material to the laminated article after removal of the device.

10. The method as recited in claim 9, wherein said sheet of material covers the surface to prevent additional accumulation of material after preparation of the surface.

11. A device for preparing a surface of a laminated article comprising:
a surface defining a first plane; and
at least three pointers supported relative to said surface, wherein each of said three pointers include a tip, said tips defining a second plane spaced a distance apart from said first plane for defining a desired thickness of the surface of the laminated article.

12. The device as recited in claim 11, including a sheet of material for covering the surface of the laminated article on a first side and engaging said surface on a second side.

13. The device as recited in claim 12, wherein said sheet of material comprises a material that is not reactive with material forming the laminated article.

14. The device as recited in claim 1, wherein said device includes a body supporting said surface and said at least three pointers in said distance apart from said first plane.

15. The device as recited in claim 14, wherein said surface comprises a plate supported on said body.

16. The device as recited in claim 15, wherein said plate includes a length and a width defining an area engaging the surface of said laminated article.

17. The device as recited in claim 14, wherein said at least three pointers are adjustable for tailoring said distance between said first plane and said second plane.

18. The device as recited in claim 14, wherein said body includes at least one handle for manipulating said device.
